(19) United States
(12) Patent Application Publication
(10) Pub. No.: US 2026/0019289 A1
(43) Pub. Date: Jan. 15, 2026

(54) BIOMETRIC RELIANT SYSTEM AND METHOD

(71) Applicant: SentryCard Technologies, Inc., Chicago, IL (US)

(72) Inventor: Mark A. COX, West Chester, PA (US)

(21) Appl. No.: 19/317,569

(22) Filed: Sep. 3, 2025

Related U.S. Application Data
(63) Continuation-in-part of application No. 19/091,174, filed on Mar. 26, 2025.
(63) Continuation-in-part of application No. 19/091,345, filed on Mar. 26, 2025.
(60) Provisional application No. 63/570,956, filed on Mar. 28, 2024.
(60) Provisional application No. 63/570,967, filed on Mar. 28, 2024.

(51) Int. Cl. H04L 9/00; G06K 19/07; H04L 9/08; H04L 9/32

(52) U.S. Cl. CPC H04L 9/50; G06K 19/0718; H04L 9/0858; H04L 9/0866; H04L 9/3231; H04L 9/3297

(57) ABSTRACT

A biometric blockchain system is provided with a card body dimensioned to approximate a standard credit card, a biometric sensor module embedded in the card body and configured to capture fingerprint or facial data, embedded electronics including at least one microcontroller unit, a cryptographic processor, and non-volatile memory, communication interfaces including at least one of near field communication or bluetooth low energy or ultra-wide band, and a power source. The biometric sensor module captures biometric data, the embedded electronics generate a cryptographic key from the biometric data using a biometric key derivation function, and the cryptographic key enables access to a private blockchain ledger for secure interactions among users with compatible cards. The card body comprises a core layer comprising a substrate film, a core sheet comprising a component section with an antenna structure and a system-in-package, and a crosslinked polymer composition disposed on both sides of the substrate film.

### CROSS-REFERENCE TO RELATED APPLICATIONS

This application is a continuation-in-part of U.S. patent application Ser. No. 19/091,174, filed Mar. 26, 2025, which claims benefit to U.S. Provisional Application No. 63/570,956, filed Mar. 28, 2024, and a continuation-in-part of U.S. patent application Ser. No. 19/091,345, filed Mar. 26, 2025, which claims benefit to U.S. Provisional Application No. 63/570,967, filed Mar. 28, 2024, both of which applications are expressly incorporated herein by reference in their entirety.

### FIELD OF THE INVENTION

The field of technology relates to biometric information carrying cards such as smart cards. Information carrying cards provide identification, authentication, data storage, and application processing. Such cards include key cards, identification cards, telephone cards, credit cards, bankcards, tags, bar code strips, and other smart cards.

Related technology involves integrating circuits into thermoplastic materials, such as polyvinyl chloride, for contact or contactless operation. Cards are becoming more complex with increased information storage and processing, particularly with advancements in artificial intelligence. Cards withstand flexing to protect electronic components and offer durability during use. Processes for making cards include injection molding, bonding, embedding, and encapsulation, where electronic components attach to or mount into a card body or cavity.

### BACKGROUND OF THE INVENTION

Biometric authentication systems have become increasingly prevalent in secure identification and access control applications. Traditional smart cards and portable security devices often rely on passwords, PINs, or static cryptographic keys to authenticate users and enable secure transactions. However, these approaches are susceptible to loss, theft, or unauthorized duplication, which can compromise the integrity of the authentication process.

To address these concerns, the integration of biometric sensors-such as fingerprint readers-into smart cards and similar devices has been developed. For example, U.S. Pat. No. 10,789,590 describes a portable device, such as a smart card, equipped with an integrated biometric sensor. In this system, the biometric sensor captures a user's biometric data (e.g., a fingerprint), which is processed locally on the device to generate a biometric template or feature set. The template is securely stored on the device, and during authentication, a new biometric sample is captured and compared to the stored template within the device. If the comparison is successful, the device enables cryptographic operations, such as releasing a cryptographic key or signing a transaction. All biometric processing and matching are performed on the device, and sensitive biometric data is not transmitted externally, thereby enhancing user privacy and security. Multiple other investigators have been issued patents related to biometrics in various combinations with distributed ledger technologies, including the following patents:

U.S. Pat. No. 8,230,099 (Juels et al.) discloses a system for generating cryptographic keys from biometric data using fuzzy extractors and error correction, enabling secure authentication without storing the key or raw biometric data. The invention emphasizes privacy-preserving key regeneration and is highly relevant to claims involving biometric-derived cryptographic keys.

U.S. Pat. No. 10,789,590 (Bourgeat et al.) describes a smart card with an integrated biometric sensor (e.g., fingerprint), on-device template storage and matching, and cryptographic operations enabled by successful biometric authentication. All processing is performed on the card, and no biometric data is transmitted externally.

U.S. Pat. No. 9,747,833 (Kumar et al.) presents a portable device with a biometric sensor that generates and stores a biometric template, which is used to unlock cryptographic keys for secure transactions. The system focuses on on-device processing and secure key management. In another disclosure, U.S. Pat. No. 9,165,867 (Kumar et al.) describes a method for generating and using cryptographic keys derived from biometric data, including the use of helper data and error correction to ensure key reproducibility. The invention addresses secure authentication and privacy concerns.

U.S. Pat. No. 9,245,314 (Bourgeat et al.) discloses a biometric smart card system where a fingerprint sensor is integrated into the card, and the card performs on-board biometric matching to enable cryptographic operations, such as digital signing and secure access.

U.S. Pat. No. 8,930,888 (Juels et al.) presents systems and methods for privacy-preserving biometric authentication, including the use of fuzzy extractors and secure key generation from biometric samples, with a focus on not storing sensitive data on the device.

U.S. Pat. No. 10,089,858 (Bourgeat et al.) describes a smart card with a biometric sensor and secure element, where biometric authentication is performed on the card to control access to cryptographic keys and enable secure transactions. In the disclosure of U.S. Pat. No. 10,430,743 (Bourgeat et al.) there is a description of a portable authentication device with a biometric sensor, on-device template matching, and cryptographic key management, emphasizing secure, user-bound authentication.

U.S. Pat. No. 9,262,755 (Kumar et al.) discloses a system for generating cryptographic keys from biometric data using error correction and helper data, with applications in secure authentication and access control.

U.S. Pat. No. 10,015,284 (Bourgeat et al.) describes a biometric smart card that performs on-device biometric matching and uses the result to enable cryptographic operations, such as digital signatures and secure communications.

U.S. Pat. No. 8,930,889 (Juels et al.) discusses methods for secure biometric authentication using fuzzy extractors and helper data, focusing on privacy and the avoidance of storing raw biometric templates.

U.S. Patent Application Publication No. 2017/0176692 (Bourgeat et al.) presents a portable device with a biometric sensor and secure element, where biometric authentication is performed on the device to control access to cryptographic keys.

U.S. Pat. No. 10,430,744 (Bourgeat et al.) discloses a smart card with integrated biometric sensing and on-device cryptographic key management, enabling secure authentication and transaction signing.

U.S. Pat. No. 10,089,859 (Bourgeat et al.) describes a system for secure authentication using a biometric smart card, with on-device biometric matching and cryptographic key management.

U.S. Pat. No. 9,262,756 (Kumar et al.) discusses methods for generating and using cryptographic keys derived from biometric data, with a focus on error correction and privacy-preserving authentication.

While such systems represent a possible advancements in secure authentication, they typically rely on the storage of biometric templates or cryptographic keys within the device. The cryptographic key is generally enabled or unlocked following successful biometric authentication, but is not regenerated from the biometric data itself for each session. Furthermore, prior art systems do not address the use of biometric-derived cryptographic keys for authentication to distributed ledger or blockchain networks, nor do they provide mechanisms for session-based key regeneration or advanced error correction in the key derivation process.

What has been needed in the art is a system and method in which a cryptographic key is regenerated from a fresh biometric sample for each authentication session, using a pipeline that includes feature extraction, salting, hashing, and error correction. The regenerated key is then used to authenticate the user to a private blockchain ledger, without storing any static private key on the device. This approach offers enhanced privacy, eliminates static key exposure, and enables secure, decentralized authentication workflows not addressed by prior systems.

### SUMMARY OF THE INVENTION

The biometric blockchain device, system, and method presented involves deployment as a secure authentication and transaction verification tool across a wide range of digital and physical environments. In one exemplary embodiment, the invention is provided as a card that includes an embedded biometric sensor, such as a capacitive fingerprint reader, and integrated electronics capable of capturing a fresh biometric sample from the user. Upon activation, the card processes the biometric data through feature extraction, salting, hashing, and error correction, thereby regenerating a cryptographic private key unique to the user and session. This key is used to sign transaction requests or authentication challenges, which are then transmitted via a communication interface—such as near field communication (NFC), Bluetooth Low Energy (BLE), or contact-based pads—to a host system or network.

The host system may be any platform requiring secure user authentication or transaction approval, including but not limited to online retailer stores, financial institutions, enterprise access control systems, government services, or peer-to-peer networks. The card's ability to regenerate the private key for each session, without storing static keys or raw biometric templates, ensures that sensitive credentials are never persistently exposed or at risk of theft. The signed transaction or authentication request can be validated by a private blockchain ledger or other distributed trust mechanism, providing an immutable and auditable record of user actions.

Third-party users, such as sellers, employees, or service providers, may also utilize the biometric blockchain card to securely access restricted resources, authorize high-value transactions, or manage account settings. The requirement for biometric authentication prior to key generation and transaction signing mitigates risks associated with password compromise, account takeover, and unauthorized access. The system's architecture supports compliance with privacy and data protection regulations by minimizing the storage and transmission of sensitive information. The invention provides a portable, user-centric solution for secure authentication and transaction verification, adaptable to a broad spectrum of applications where trust, privacy, and security are essential.

In one aspect, the present disclosure provides a system for secure messaging comprising a biometric blockchain card with a layered core embedding a biometric sensor and a communication interface. The card, powered by a power source, is configured to capture biometric samples, pre-process the samples to create encrypted templates stored in memory, extract features from the samples, transform the features via hashing with a salt, correct using error correction to yield a cryptographic private key, authenticate to a private ledger using the private key, broadcast a join request via the communication interface for validation by consensus to add a user, and derive session keys for encrypted messages logged as hashes on-chain for trust verification among group members. This system enhances security through biometric-derived keys and decentralized blockchain verification, enabling portable and trusted networks for data exchange.

In another aspect, the present disclosure provides a method for secure messaging using a biometric blockchain card. The method includes capturing biometric samples with a biometric sensor embedded in a layered core of the card powered by a power source, pre-processing the samples to create encrypted templates stored in memory, extracting features from the samples, transforming the features via hashing with a salt, correcting the transformed features using error correction to yield a cryptographic private key, authenticating to a private ledger using the private key, broadcasting a join request via a communication interface embedded in the layered core for validation by consensus to add a user, and deriving session keys for encrypted messages logged as hashes on-chain for trust verification among group members. This method facilitates decentralized authentication and secure interactions, leveraging biometric data for key generation and blockchain for immutable trust.

In a further aspect, the present disclosure provides a method for secure communication using a biometric blockchain card. The method comprises capturing biometric data with a biometric sensor embedded in a layered core of the card powered by a power source, processing the data to generate encrypted templates stored in memory, extracting features from the data, transforming the features through hashing with a salt, applying error correction to the transformed features to produce a cryptographic private key, authenticating to a private blockchain ledger using the private key, transmitting a join request via a communication interface embedded in the layered core for validation by a consensus mechanism to register a user, and generating session keys for encrypted communications recorded as hashes on the ledger for trust verification among network participants. This approach ensures privacy-preserving authentication and scalable secure exchanges via biometric integration with blockchain technology.

In yet another aspect, the present disclosure provides a method for secure communication using a biometric blockchain card. The method involves capturing biometric data with a biometric sensor embedded in a layered core of the card powered by a power source, processing the data to generate encrypted templates stored in a memory, extracting features from the data, transforming the extracted features through hashing with a salt, applying error correction to the transformed features to generate a cryptographic private key, authenticating to a private blockchain ledger using the private key, transmitting a join request via a communication interface embedded in the layered core where the request is validated by a consensus mechanism to register a user, and generating session keys for encrypted communications recorded as hashes on the ledger to verify trust among network participants. This method promotes self-sovereign identity and encrypted data integrity through biometric key derivation and distributed ledger consensus.

In an additional aspect, the present disclosure provides a method for secure communication using a biometric blockchain system. The method includes capturing biometric data with a biometric sensor powered by a power source, processing the data to generate encrypted templates stored in a memory, extracting features from the data, transforming the extracted features through hashing with a salt, applying error correction to the transformed features to generate a cryptographic private key, authenticating to a private blockchain ledger using the private key, transmitting a join request via a communication interface where the request is validated by a consensus mechanism to register a user, and generating session keys for encrypted communications recorded as hashes on the ledger to verify trust among network participants. This generalized method enables flexible biometric authentication and blockchain-based secure networking across various device form factors.

In a further aspect, the present disclosure provides a biometric blockchain device for secure communication comprising a biometric sensor powered by induced voltages captured from an electromagnetic field and configured to capture biometric data, a memory configured to store encrypted templates generated by processing the data, a processor configured to extract features from the data, transform the extracted features through hashing with a salt, apply error correction to the transformed features to generate a cryptographic private key, and authenticate to a private blockchain ledger using the private key, and a communication interface comprising an application running on a smartphone configured to transmit a join request for validation by a consensus mechanism to register a user and generate session keys for encrypted communications recorded as hashes on the ledger to verify trust among network participants. This device leverages energy harvesting for portability and biometric processing for enhanced security in decentralized communications.

### BRIEF DESCRIPTION OF THE DRAWINGS

FIG. 1 is a perspective view of a biometric reliant system located on a card including a biometric sensor, a microcontroller unit, a cryptographic processor, memory, and a communication interface;

FIG. 2 is an exploded view of the card body structure shown in FIG. 1, depicting a layered core with thermoplastic layers, through-holes, cutouts, and embedded electronics encapsulation.

FIG. 3 is a plan view of a layer as shown in FIG. 2, having an exemplary biometric sensor module, depicting a capacitive fingerprint reader used in combination with an NFC suitable antennae module and supporting electronics.

FIG. 4 is a plan view of another layer similar to FIG. 3, having an exemplary biometric sensor module, depicting a microcontroller unit used in combination with an NFC suitable antennae module and supporting electronics

FIG. 5 is an isometric perspective view of a biometric reliant system located on a card in near-field proximity to a smart phone running an API configured for use in some embodiments of the invention;

FIG. 6 is a flowchart illustrating operation of the system and method of the invention including feature extraction, hashing, error correction, key output steps, blockchain integration, authentication, joining, and secure interactions with consensus mechanisms and cryptographic key generation process.

### DETAILED DESCRIPTION OF PREFERRED EMBODIMENTS

This description of exemplary embodiments is intended to be read in connection with the accompanying drawings, which are to be considered part of the entire written description. In the description, relative terms such as lower, upper, horizontal, vertical, above, below, up, down, top, and bottom as well as derivatives thereof are to be construed to refer to the orientation as then described or as shown in the drawing under discussion. These relative terms are for convenience of description and do not require that the apparatus be constructed or operated in a particular orientation. Terms concerning attachments, coupling, and the like, such as connected and interconnected, refer to a relationship wherein structures are secured or attached to one another either directly or indirectly through intervening structures, as well as both movable or rigid attachments or relationships, unless expressly described otherwise. For purposes of the description hereinafter, it is to be understood that the embodiments described below may assume alternative variations and embodiments. It is also to be understood that the specific articles, compositions, and processes described herein are exemplary and should not be considered as limiting.

In the present disclosure the singular forms a, an, and the include the plural reference, and reference to a particular numerical value includes at least that particular value, unless the context clearly indicates otherwise. When values are expressed as approximations, by use of the antecedent about, it will be understood that the particular value forms another embodiment. As used herein, about X, where X is a numerical value, refers to +10% of the recited value, inclusive. For example, the phrase about 8 refers to a value of 7.2 to 8.8, inclusive. Where present, all ranges are inclusive and combinable. For example, when a range of 1 to 5 is recited, the recited range should be construed as including ranges 1 to 4, 1 to 3, 1-2, 1-2 & 4-5, 1-3 & 5, 2-5, and the like. In addition, when a list of alternatives is positively provided, such listing can be interpreted to mean that any of the alternatives may be excluded, for example, by a negative limitation in the claims. For example, when a range of 1 to 5 is recited, the recited range may be construed as including situations whereby any of 1, 2, 3, 4, or 5 are negatively excluded; thus, a recitation of 1 to 5 may be construed as 1 and 3-5, but not 2, or simply wherein 2 is not included. It is intended that any component, element, attribute, or step that is positively recited herein may be explicitly excluded in the claims, whether such components, elements, attributes, or steps are listed as alternatives or whether they are recited in isolation.

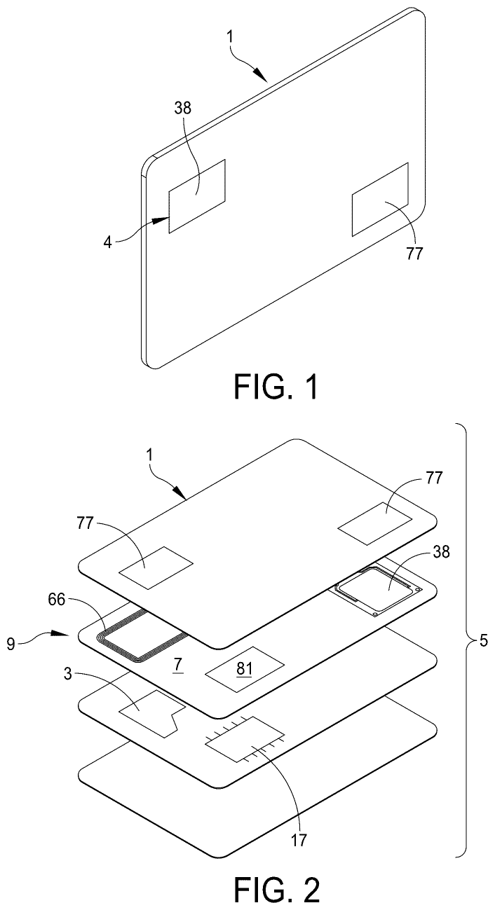

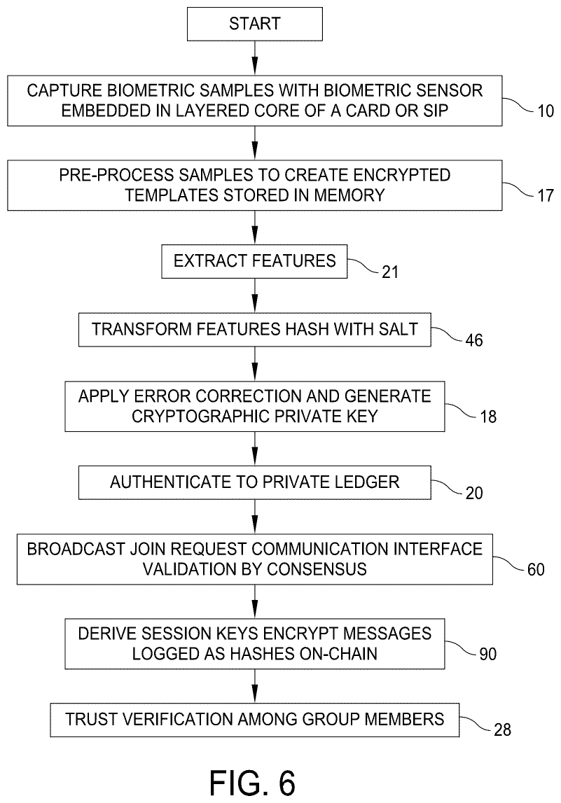

Referring to FIGS. 1 and 6, a biometric authentication device 1 may be integrated with blockchain technology for secure, decentralized access and interactions. The devices may be formed so as to have a credit card-sized form factor, although other form factors are suitable for use with the invention. The biometric authentication device is often equipped with biometric sensor module 4 and embedded electronics configured to generate cryptographic private key 18 from user biometrics often referred to herein as “phenocrypts”, facilitating authenticated access to a private blockchain ledger 20. The invention can also be manufactured as a plug-in or stand-alone component, e.g., a system in package (SIP) or system on card (SOC).

The invention is suitable for use in trusted networks where multiple users with compatible cards can participate in secure operations, such as exchanging encrypted data, with trust verified through an immutable private blockchain ledger 20. In one embodiment, a phenocrypt reliant, biometric authentication device 1 takes the form of a card, in other embodiments biometric authentication device 1 may form a portion of a SIP or SOC that is preferably form factor independent, e.g., when facilitating tokenized payments. In other embodiments, the biometric authentication device 1 takes the form of a card dimensioned to approximate a standard credit card form factor, for example, 85.6 mm×53.98 mm×0.76 mm, ensuring portability for integration into wallets or keychains, often adhering to applicable standards for card bodies. In some embodiments, the biometric authentication device 1 is formed of a metallic or partially metallic core layer, for example, stainless steel, tungsten, or conductive non-metal materials like ceramics, for durability and a premium feel, with non-conductive portions to support electromagnetic functionality. Alternatively, the biometric authentication device 1 may be formed from non-metallic materials such as polyvinyl chloride (PVC), polyethylene terephthalate (PET), polyolefin, polycarbonate, polyester, polyamide, or acrylonitrile butadiene styrene copolymer (ABS), selected for flexibility, strength, and resiliency. PVC refers to polyvinyl chloride. PET refers to polyethylene terephthalate. ABS refers to acrylonitrile butadiene styrene copolymer.

Referring to FIGS. 1-3, a biometrically activated blockchain card core 3, often a SIP or SOC, includes a layered structure 5 with a first thermoplastic layer as the base, for example, 0.01-0.05 mm thick, transparent, a second thermoplastic layer, for example, 0.1-1.1 mm thick, transparent or opaque, defining through-holes or cutouts for component placement, and optionally a third thermoplastic layer on top. Cutouts in the body the card, for example, circular, square, or rectangular portions, positioned adjacent to edges, are configured to receive embedded elements, with dimensions ensuring a gap of at least 150 microns, sometimes up to 2000 microns, between components and the cutout edge for electromagnetic isolation, reducing eddy currents in conductive materials. Discontinuities, such as sinuous lines extending from an outer edge to the cutout forming channels with curved and straight portions, create flexible fingers arranged in parallel to distribute pressure and prevent cracking, providing a flex profile similar to a continuous body while enhancing isolation.

Embedded electronics 7 are integrated via inlay layers, for example, on supporting films like polyimide or PET, placed within the through-holes, encapsulated by a crosslinkable polymer composition dispensed in portions: first between layers, then filling through-holes, and finally over the inlays. This polymer, for example, acrylate, methacrylate, urethane acrylate, silicone, or epoxy-based, with initiators, cures to form a flexible, transparent solid with Shore D hardness of 10-85 and tensile strength of 20-100 MPa, protecting components during use.

As a card, the biometric authentication device 1 further includes a core layer 9 configured to be used for making the biometric authentication card, comprising a substrate film, a core sheet comprising a component section, wherein the component section comprises antenna structure 66 disposed on or at least partially embedded within the substrate film, the antenna structure 66 comprising a wire made of a conductive material, and a system-in-package (SIP) 11 comprising at least one chip, e.g., MCU or IC, disposed on or embedded within the substrate film, and electrically connected with the antenna structure 66, and a crosslinked polymer composition disposed on both sides of the substrate film, wherein the substrate film is centered in the crosslinked composition in a direction normal to a plane of the core layer. The substrate film often includes a polymer, a paper, plasticized paper, a composite, or any combination thereof. The substrate film is a first thermoplastic layer made of a thermoplastic polymer. The antenna structure 66 is made of a wire or a thread, and the conductive material comprises a metal. The conductive material is made of copper or copper alloy. The antenna structure 66 and the system-in-package 11 are connected by laser melting of the conductive material or by a conductive tape. The system-in-package 11 comprises at least two or three chips for different functions. The antenna structure 66 is configured to generate energy through induction in a magnetic field, and the core layer includes no battery. The system-in-package 11 includes at least two chips. The core layer further comprises a light emitting diode 13 electrically connected with the system-in-package 11 and the antenna structure 66. A core sheet including the substrate film, the antenna structure 66 and the system-in-package 11 is self-centered in a crosslinkable polymer during curing in a thermal lamination process under a temperature and a pressure.

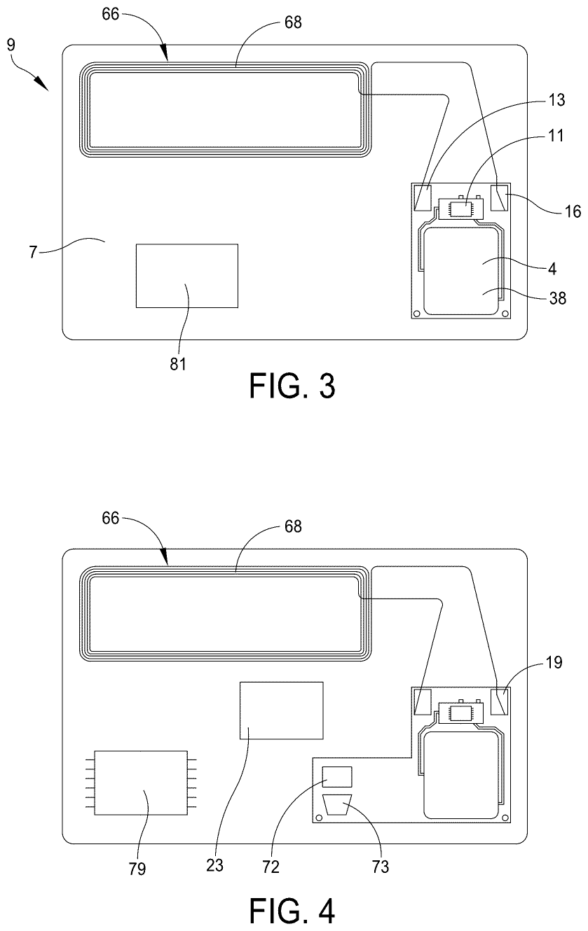

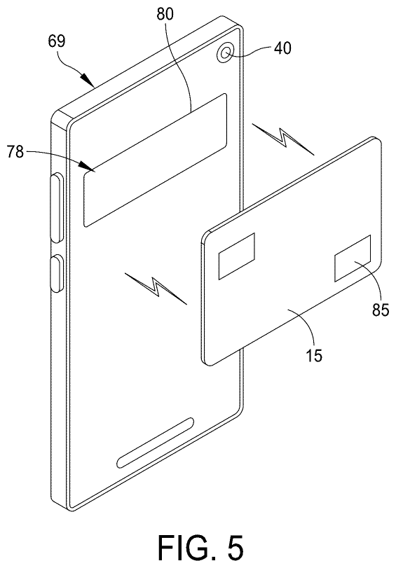

In one example, a biometric sensor module 4 is configured to capture fingerprint or facial data, such as capacitive fingerprint reader 38 integrated into the surface of the body of biometric authentication device 1, occupying approximately 10 mm×10 mm, or in combination with miniature complementary metal-oxide-semiconductor (CMOS) camera 40 located, e.g., on a smart phone 69, with infrared capabilities for facial recognition, or one positioned along the edge 15 of biometric authentication device 1. The sensor supports match-on-card application processing, comparing captured templates against stored ones for authentication. Biometric sensor module 4 incorporates structures where the capacitive fingerprint reader 38 may be embedded or entombed in the biometric authentication device 1 as a capacitive array sensor, consisting of a grid of electrodes on a silicon substrate that detects ridge and valley patterns through capacitance changes. This sensor is integrated into the surface of biometric authentication device 1 via a thin protective overlay, allowing direct finger contact sensing, while maintaining the device's flexibility. The biometric sensor module 4 includes a dedicated processor 16 (FIG. 3) for template generation, which converts raw capacitance data into a digital minutiae map using algorithms, for example, ridge detection. For facial recognition, the miniature complementary metal-oxide-semiconductor (CMOS) camera 40 located on smart phone 69 features a lens system with infrared capabilities for low-light operation, mounted in a recessed edge 15 cutout to minimize protrusion.

The biometric authentication card embodiment avoids storing static private keys on the device by regenerating the cryptographic private key from a fresh biometric sample each time authentication is required. The key is derived dynamically through a process involving biometric feature extraction, salting, hashing, and error correction, ensuring that no persistent private key resides in device memory. As a result, attackers cannot extract a key through physical tampering, side-channel attacks, or malware, since there is no static key present to target. If a device is cloned, duplication alone is insufficient for unauthorized access because the private key can only be regenerated with the legitimate user's unique biometric input. The system also enhances biometric privacy by not storing raw biometric data or templates that could be compromised; only non-sensitive helper data for error correction may be stored, and the key is regenerated only when the authorized user presents their biometric trait. Since the private key exists only transiently in device memory during authentication, the opportunity for interception or leakage is minimized. Furthermore, this approach aligns with privacy-by-design principles and reduces regulatory risk, as many data protection laws and standards (such as GDPR) require minimization of sensitive data storage. By avoiding static private key storage, the system significantly reduces the risk of key compromise, prevents device cloning, protects user biometrics, and supports compliance with privacy regulations, resulting in a more secure and privacy-preserving authentication solution.

Returning to FIGS. 1-3, biometric sensor module 4 supports liveness detection through integrated structures like pulse oximetry diodes 72 for fingerprints, measuring blood flow via light absorption at multiple wavelengths. Or, sonic sensors 73, where sound is used to detect the epidermis layers uniqueness and blood flow. For match-on-card applications a secure applet on the smart card chip is utilized, storing encrypted templates in non-volatile memory partitions and performing comparisons via Euclidean distance metrics. Enrollment mode activates via a user interface button 77, capturing multiple samples to build robust templates with error tolerance.

The biometric sensor module 4 interfaces with the microcontroller unit 79 through a serial bus, ensuring data isolation with encryption layers to prevent interception. In a further example, biometric sensor module 4 is tamper-resistant integration, enclosing the sensor in a polymer-encapsulated inlay within the card core's through-hole, providing physical protection against moisture, bending or impact. An optical variant includes anti-spoofing filters, such as polarization lenses to detect synthetic materials. Power management structures route low-voltage supply from the antenna structure 66 of biometric authentication device 1, battery (not shown) or other power source, with wake-on-touch capacitors to activate only during use, conserving energy. These features ensure reliable operation in a portable card-based form factor while enhancing security against forgery.

Embedded electronics include at least one microcontroller unit (MCU) 79, SIP 11, SOC 81, or microprocessor, for example, dual-interface type like NXP, SmartMx, for managing operations, a cryptographic processor 17 for key generation 18, and non-volatile memory, for example, persistent storage integral or external to the controller, for secure data. A separate biometric authentication device 1 controller handles functionality like dynamic data emission. For example, the microcontroller unit 79 is a dual-interface microprocessor capable of contact or contactless communication. The microcontroller unit 79 coordinates biometric data processing, interfacing with biometric sensor module 4 via serial peripheral interface lines, inter-integrated circuit ports or universal asynchronous receiver-transmitter communication interface, and executing firmware for template matching. The cryptographic processor is often an integrated co-processor supporting advanced encryption standard 256 encryption and elliptic curve cryptography (ECC) private key 18 generation, e.g., AES, RSA, ECC, Kyber, Dilithium, SPHINCS+, ChaCha20, Twofish, Serpent, Blowfish, 3DES, EdDSA, ECDSA, with hardware accelerators for hashing functions like secure hash algorithm 256 (SHA-256) 44.

Non-volatile memory may form a portion of a biometric reliant system in accordance with several embodiments, e.g., electrically erasable programmable read-only memory arrays partitioned for secure storage, often with tamper-detection fuses. In one example, a separate card controller is employed as a dedicated application-specific integrated circuit for dynamic data emission, generating time-varying codes via a random number generator seeded by biometric inputs. The card controller, if present, modulates signals for transaction compatibility. The electronics are mounted on a flexible printed circuit board inlay within the card's core, connected by fine-pitch traces to minimize electromagnetic interference. Power gating circuits allow the microcontroller unit to enter sleep modes, drawing less than 1 μA, activated by sensor interrupts. An error-correcting random access memory buffer is disposed in connection with the memory for data integrity and a watchdog timer in the microcontroller unit to prevent hangs during key operations. The cryptographic processor 17 includes side-channel attack resistance through constant-time algorithms for randomized computations, and is encapsulated in epoxy resin for environmental protection, with thermal vias to dissipate heat from processing.

Integration with the blockchain module 23 occurs via shared buses, enabling key signing for private blockchain ledger 20 access. The embedded electronics are provided in the form of a system-in-package 11 comprising multiple chips for different functions, such as a chip encoded with security protocols, a biometric sensor chip, and a chip for accepting biometric data. The system-in-package 11 is disposed on a base layer or directly on the substrate film. The biometric sensor chip 4 has a surface 38 configured to be touched by a finger of a biometric authentication device 1 holder and includes a microcontroller disposed underneath. The biometric sensor chip 4 is configured to be turned on by power generated in the antenna structure 66 and to collect biometric patterns such as fingerprint patterns. The biometric patterns are compared to profiles in the security protocols to verify the identity of the card holder.

Communication interfaces include near field communication (NFC) 78 via an integrated antenna 66, for example, concentric wire coils, 50-300 microns thick, compliant with ISO/IEC 14443 compliance, ultra-wide band, bluetooth low energy (BLE), or contact-based pads, for example, ISO/IEC 7816 compliant. Inductive coils, printed copper traces or wound copper around an insulating core, enable swipe-activation or contactless modes. The near field communication (NFC) 78 interface uses a concentric wire coil antenna 66 etched on the substrate layer, often having 2-8 turns of 50-300-micron copper wire tuned to 13.56 MHz radio frequency signals 70 for ISO/IEC 14443 compliance. The antenna 66 couples to the microcontroller unit 79 via a matching circuit including capacitors for impedance optimization. The bluetooth low energy (BLE) module is a low-power radio chip operating, often at 2.4 GHz, with an integrated balun for antenna matching and support for BLE 5.0 protocols. In one less advantageous embodiment, a USB-C connectivity features a reversible connector with differential pairs for high-speed data, compliant with USB 2.0 specifications. Contact-based pads may often be gold-plated contacts arranged, for example only, in 4, 6 or 8-pad ISO/IEC 7816 layout, connected to the smart card chip for secure data exchange.

Additional structures may include radio frequency shielding layers around the antenna 66 to reduce interference, and power harvesting rectifiers for contactless modes. The bluetooth low energy (BLE) chip includes a 128-bit advanced encryption standard engine for encrypted links, while near field communication (NFC) 78 supports near field communication data exchange format formatting for blockchain data. Integration involves fine-pitch soldering, or wire bonding to the inlay printed circuit board, with test points for manufacturing verification. These circuit structures enable seamless host device communication, such as with smartphone apps, while maintaining low power consumption. Integrations may also utilize other conductive films, e.g., ACF, ACP or conductive adhesive layers.

An optional power source is placed onboard for certain applications, such as a thin-film battery, for example, FLEXION ultra-thin lithium polymer or lithium thin-film from Varta Microbattery GmbH, supplemented by energy-harvesting modules, for example, from radio frequency signals at 13.56 MHz or electromagnetic fields via antenna structure 66 and inductive coils 68. The controller maintains an off or sleep state drawing zero power until activated by a signal exceeding a threshold, for example, 0.5V, harvested without battery drain. In one embodiment, a thin-film lithium polymer cell with a flexible electrode stack, measuring 0.1-0.3 mm thick and providing between 1.5 and 3.7V nominal voltage depending on the integrated circuit requirement. The battery is embedded in a core cutout, connected via conductive adhesive, ultrasonic bond or solder to the microcontroller unit power rails. Energy-harvesting modules use rectenna circuits tuned to 13.56 MHz radio frequency signals, converting electromagnetic energy via Schottky diodes into direct current voltage.

An inductive coupling circuit includes a rectifier bridge and capacitor bank for smoothing, supplementing the battery during near field communication (NFC) 78 operations, if a battery is employed. The controller's sleep state is managed by a low-power comparator monitoring input signals, activating at 0.5V threshold without drawing quiescent current. Harvested energy powers a wake-up interrupt, transitioning the microcontroller unit from off-state to active in under 1 ms. Battery management structures sometimes include a charge controller preventing over-discharge via voltage monitoring, extending lifecycle to 500+ cycles. The thin-film design uses solid-state electrolytes for safety, integrated on the substrate layer. In one embodiment, thin film solar collectors are deployed to generate required voltages without the need for batteries or induced currents. In another example, the power system features dynamic power gating for components like the cryptographic processor, reducing consumption to less than 10 μA in standby. Energy from a reader device is captured via inductive coils 68, generating pulses for bootstrap powering. These structures ensure reliable operation in portable scenarios, with fault-tolerant redundancies like backup capacitors for brief outages.

Optional elements such as a display, for example, liquid crystal display, light emitting diode, polymer organic light emitting diode or organic light emitting diode, electrophoretic, electronic paper, or 6-digit 7-segment for showing dynamic codes, or to display any form of communication or any bistable display, light emitting diode indicators, switches, or capacitive sense buttons, embedded in cutouts for co-planar integration. The optional elements include a display structure where the liquid crystal display or electronic paper screen is a low-power bistable panel embedded in a surface cutout, connected via flexible flat cable to the controller, or directly to a circuit by ACF, ACP, soldering or conductive film.

Electronic paper variants use microcapsule technology for zero-power retention, activated by voltage pulses. The 7-segment format supports numeric output for verification codes, with anti-reflective coating. Matrixed displays have also been found to provide adequate results. Exemplary power sources may be driven by the card controller for dynamic light emitting diode indicators are surface-mounted diodes in various colors, signaling status like authentication success with low current draw. Switches may be mechanical tactile buttons 85 embedded in cutouts, providing user input for mode selection. Capacitive sense buttons use electrode pads under the card surface, detecting touch via capacitance changes, integrated with the microcontroller unit's analog-to-digital converter for gesture recognition. All elements are co-planar via precision cutouts, encapsulated for durability, and powered selectively to conserve energy. These additions enhance usability, with tamper-evident seals around sensitive parts.

The structure ensures security through tamper-proof embedding via cured polymer and isolation gaps, with components like antenna structure 66 and system in package 11 or system-on-chip 81 elements positioned to avoid interference, supporting both contact and contactless operations.

A core layer for forming biometric authentication device 1 in card form is made by forming the core sheet on the substrate film, applying a crosslinkable polymer composition in a liquid or paste form to both sides of the core sheet in a press for lamination, and curing the crosslinkable polymer composition through heating or radiation under a pressure so as to form the core layer, wherein the crosslinkable polymer composition is converted into the crosslinked polymer composition. Forming the core sheet on the substrate film comprises providing the system-in-package in the component section of the core sheet on the substrate film, providing or forming the antenna structure 66 in the component section of the core sheet on the substrate film, and electrically connecting the antenna structure 66 with the system-in-package in the component section of the core sheet. The antenna structure 66 and the system-in-package 11 are connected by laser melting of the conductive material or by a conductive tape. The conductive material in the antenna structure 66 is applied on the substrate film through vapor deposition, printing, or cladding technique, or any combination thereof.

Turning now to an exemplary aspect of the invention, biometric sensor module 4 includes one or more sensors embedded or entombed directly into, e.g., the card body of biometric authentication device 1. This technique advantageously allows the sensor to be waterproof, flexible, and manufactured in standard SMT assembly machines. This arrangement advantageously allows for larger tolerances for common card extraction machines greatly improving yield rates. Component level sensor, also rarely require costly finish packaging by foundries or packaging companies, greatly lowering the cost of the sensor. These biometric sensor module 4 are arranged for use in capturing phenocrypts derived from physiological data, e.g., fingerprints, dna, rna, bone surface anomalies, iris patterns, retinal blood vessels, palm veins, facial geometry, palm prints, hand geometry, odor/scent, voice patterns, ear shape, gait, typing rhythm, signature dynamics, electrocardiogram patterns, electroencephalogram patterns, finger vein patterns, behavioral profiling, mouse movement patterns. Sensor that are useful for inclusion in various embodiments of the invention may include capacitive fingerprint reader 38 or miniature complementary metal-oxide-semiconductor (CMOS) camera 40, for example, with infrared capabilities for facial recognition.

In configurations focused on fingerprint authentication, biometric sensor module 4 is embedded directly into the body of biometric authentication device 1 or as part of an activation interface detecting ridge and valley patterns via an electrode array or optical imaging. For facial recognition, biometric sensor module 4 often includes a 1-megapixel camera positioned along the edge 15 of biometric authentication device 1, enabling user alignment within a limited field of view, for example, 30-45 degrees, suitable for close-range scanning. Adjustable capacitive sensing power available in the component allows for more card finishing options. Integration of biometric sensor module 4 follows layered embedding techniques, where the sensor module is placed within designated cutouts in card core and connected to the card's internal bus, for example, serial peripheral interface, for communication with the microcontroller unit 79 or smart card chip. This allows standalone operation or interfacing with external activation units via contact, for example, ISO/IEC 7816 compliant pads, or contactless, for example, ISO/IEC 14443 antenna 66, methods. Materials for the sensor include standard semiconductor substrates, for example, silicon for capacitive arrays, encapsulated in protective polymers to withstand flexing and environmental stress, ensuring durability in a thin form factor.

Biometric data 10 capture and processing involves generating a live image or scan of the user's trait, which is then converted into a digital template or phenocrypt. For fingerprints, the sensor captures a high-resolution image, for example, 500 dpi or higher, of the live fingerprint, processing it through software on the microcontroller unit 79 or a dedicated processor to extract features 21 like minutiae points. Facial scans similarly capture live images, extracting landmarks, for example, eye spacing, nose bridge, using algorithms such as Viola-Jones for detection or deep learning models for feature mapping. The raw data undergoes analog-to-digital conversion, followed by pre-processing algorithms such as Gaussian filtering for noise reduction, histogram equalization for contrast enhancement, or edge detection, for example, Canny algorithm, to refine features and improve accuracy.

Security features emphasize on-device processing to minimize data exposure. A match-on-card application resident on the smart card chip or microcontroller unit 79 compares the generated template against pre-stored templates enrolled during setup, using similarity metrics like Euclidean distance metrics or neural network-based scoring. To counter spoofing, liveness detection may be incorporated: for fingerprints, techniques such as pulse oximetry diodes 72 measuring blood flow via infrared light absorption or sweat pore analysis ensure the input is from a live finger; for facial scans, blink detection, thermal imaging if infrared-enabled, or challenge-response, for example, prompting a smile, verify authenticity. Also, a sonic sensor for delivering sound waves into the users body, e.g., into one or more fingers, reads the uniqueness of the epidermis layer and determines if blood is flowing. Failed authentications trigger lockouts, for example, temporary disablement after three attempts, preventing brute-force attacks.

Operational flows include enrollment and authentication processes. During enrollment, the user activates the system directly, using near field communication (NFC) 78 power induction or direct connect methods, capturing multiple biometric samples, for example, 3-5 fingerprints or facial poses, to create robust templates stored in secure, non-volatile memory on the card chip. These templates are encrypted templates and never transmitted off-card. In authentication mode, the sensor captures a live scan, generates a template, and performs the match-on-card application comparison; a successful match, for example, a score at or above an adjustable threshold which allows for lower or higher pass-fail rates, unlocks key generation 18, while failure logs the event for auditing. Embodiments vary from standalone sensors for direct card use, to hybrid setups with external activation units for enhanced processing power. Interfaces ensure seamless data flow, with the sensor communicating templates to the cryptographic processor via internal buses, integrating biometric verification into the overall key derivation workflow.

Upon successful biometric data 10 capture and match-on-card application verification, the embedded electronics generate a cryptographic private key 18 using a biometric key derivation function, transforming variable biometric data 10 phenocrypts into a consistent, high-entropy key suitable for cryptographic operations. This process ensures the key is user-dependent and reproducible without storing raw biometrics, enhancing privacy and security against template theft. In an exemplary configuration, the process begins with feature extraction from the biometric template: for fingerprints, minutiae points, for example, ridge endings, bifurcations, are identified using algorithms like crossing number or Gabor filtering, forming a feature vector of 100-200 points; for facial data, landmarks, for example, via dlib library or similar, are extracted alongside texture descriptors like local binary patterns. This vector undergoes a user-dependent distinguishable feature transform, such as binarization or quantization, to create a stable bitstring, for example, 256-512 bits, tolerant to noise. The transform includes alignment steps, such as rotation-invariant mapping for fingerprints or affine transformations for faces, to handle positional variations.

Next, the feature vector is hashed using a secure one-way function 87, for example, secure hash algorithm 256 (SHA-256) or Argon2 for memory-hard resistance, combined with a user-specific salt 46, for example, a random 128-bit value generated during enrollment and stored in tamper-resistant memory. To address biometric variability due to pressure, angle, or lighting, error-correcting codes are applied: fuzzy extractors based on Reed-Solomon codes or Bose-Chaudhuri-Hocquenghem codes correct errors within a tolerance, for example, Hamming distance less than 10-20%, ensuring key reproducibility across scans while binding the key to the biometrics irreversibly.

Helper data, non-sensitive parity bits from the extractor, is stored on-device to aid reconstruction without revealing the original template. The output is an elliptic curve cryptography (ECC) private key, for example, which could be based upon the secp256k1 curve, 256 bits, from which a public key is derived for private blockchain ledger 20 interactions. In other embodiments, the key is transformed or unlocked via biometric input in a cryptosystem, such as binding it to a master key using secure multi-party computation or threshold schemes for added resilience. Key generation occurs entirely on-device in a secure enclave, for example, ARM TrustZone equivalent, preventing external exposure, with runtime checks for entropy levels, for example, greater than 128 bits, to reject weak derivations. Revocation mechanisms allow key regeneration upon template update, invalidating prior keys via private blockchain ledger 20 revocation lists.

The cryptographic private key 18 enables access to a private blockchain ledger 20, configured as a permissioned network, for example, based on Hyperledger Fabric or a modified Ethereum framework with proof-of-authority consensus 60, where nodes are controlled by authenticated users or trusted entities. The ledger records user authentications, transactions, and network memberships in an immutable, distributed format, leveraging biometric verification to confirm contributor identities in transactions. This integration supports decentralized identity authentication, where biometrics bind keys to users without central authorities. For example, core operations include user authentication. The key signs a challenge-response protocol, for example, nonce-based, to verify possession and biometric linkage, granting read/write access. Biometric data 10 hashes are stored on-chain for verification, using zero-knowledge proofs (zk-SNARKs) to prove identity without revealing templates.

Users with compatible cards join by broadcasting a signed join request 26, for example, via bluetooth low energy (BLE) peer discovery or near field communication (NFC) 78, including their public key and a biometric-derived proof. The private blockchain ledger 20 consensus mechanism 28, for example, practical Byzantine fault tolerance (PBFT) 62 with 3f+1 nodes, validates the request against enrollment criteria, adding the member's key to a smart contract-managed access list. This creates self-sovereign networks, with revocation via on-chain events.

For encrypted data exchange, users derive symmetric keys 90 from private blockchain ledger 20-authenticated sessions, for example, via Diffie-Hellman, bound to biometric keys. The ledger stores transaction metadata (timestamps), hashes, for auditability, with smart contracts enforcing rules, for example, multi-signature approvals. Off-chain data is linked via hashes, ensuring privacy while verifying integrity. The card interfaces with the private blockchain ledger 20 through a host device, for example, application running on a smartphone 69 as gateway for peer-to-peer synchronization, or direct low-power radio for peer-to-peer synchronization. Scalability is achieved via sharding or sidechains, with biometric re-authentication for high-value operations.

As one example, a biometric blockchain device according to one embodiment of the invention provides secure communication with a biometric sensor that is powered powered by a power source and configured to capture biometric data. A memory is provided and configured to store encrypted templates generated by processing the biometric data. A processor is configured to extract features from the biometric data, transform the extracted features through hashing with a salt, and apply error correction to the transformed features to generate a cryptographic private key, that is then used to authenticate to a private blockchain ledger. In this way, a communication interface which is configured to transmit a join request for validation by a consensus mechanism to register the user and to generate session keys for encrypted communications so that the encrypted communications recorded as hashes on the private blockchain ledger verify trust among network participants.

Exemplary aspects offer enhanced security through biometric-based key derivation, portability via compact form factor, and decentralized trust through private blockchain ledger 20 integration. Alternative configurations include additional biometric modalities, for example, voice recognition, or adaptation for public blockchains with privacy-preserving techniques, such as zero-knowledge proofs (zk-SNARKs). Further variations employ post-quantum cryptographic algorithms, for example, lattice-based cryptography, to future-proof security. Those skilled in the art will appreciate that modifications, such as varying sensor types or blockchain protocols, may be implemented while remaining within the scope of the disclosed technology.

In another exemplary application of the invention, a Visa Verification and Real-Time Compliance system may be produced in accordance with multiple embodiments of the invention. In particular, an integration with visa verification systems, including U.S. Citizenship and Immigration Services (USCIS) and Department of Labor (DOL) APIs, enables automated eligibility checks for H-2A and H-2B visa programs. In accordance with Department of Homeland Security (DHS) regulations effective Jan. 17, 2025, visa status is synchronized with the blockchain-stored identity, reducing processing backlogs and ensuring that only authorized workers are onboarded. Worker activities may be monitored in real-time using GPS data collected from the user device. An AI model, such as a transformer-based architecture, analyzes sequential data from GPS check-ins and work logs. Self-attention mechanisms within the model detect patterns indicative of compliance or potential violations, such as overstays or labor abuses. When anomalies are detected, alerts are automatically triggered for employers or regulatory authorities. Automated compliance reports may be generated for regulatory audits, including audit-ready logs of wages, location data, and performance metrics. Anti-exploitation safeguards are incorporated, such as anonymous reporting channels for labor abuses. The system also supports integration with international organizations for tracking refugee employment and disbursing climate-smart subsidies. A biometric-based identity is designed for secure, cross-border portability, enabling workers to access trade financing, subsidies, ESG incentives, and remittances through an integrated financial platform. The system of the invention is scalable, supporting the onboarding of multiple users across different countries and facilitating visa coordination, wage disbursements, and remittances that may exceed predefined thresholds. Data privacy is maintained through quantization and pruning techniques applied to the neural network models, reducing the risk of data leakage while optimizing for low-power operation on edge devices such as mobile phones used in remote agricultural settings. Hardware accelerators, including tensor processing units (TPUs) or application-specific integrated circuits (ASICs), may be incorporated to further enhance processing efficiency.

By combining the biometric authentication device 1 with biometric processing via neural networks, blockchain-based identity storage, AI-driven compliance monitoring, and direct integration with updated visa regulations, this system delivers a robust, scalable, and secure solution for agricultural labor management. The approach addresses identity verification, worker protections, regulatory compliance, and financial inclusion in a manner that distinguishes it from prior solutions.

Furthermore, the systems and methods of the invention may be integrated into an on-line retailer store's e-commerce platform to enhance both security and user experience. In the context of a hybrid business model—wherein millions of third-party sellers and the retailer itself offer products to a global customer base—the need for robust, user-friendly authentication and transaction verification is paramount. The biometric blockchain card enables customers to authenticate their identity and authorize purchases using a simple biometric gesture, such as a fingerprint scan, directly on a secure card. This approach eliminates the reliance on static passwords or stored payment credentials, which are susceptible to theft, phishing, and unauthorized use.

When a customer initiates a purchase on the on-line retailer store's platform, the system prompts the user to present their biometric blockchain card to a compatible device, such as a smartphone or dedicated reader. The card captures a fresh biometric sample, regenerates a cryptographic private key using the methods described herein, and signs a transaction request. This signed request is then transmitted to the retailer's backend systems or a dedicated permissioned blockchain ledger, where it is validated and logged. Because the private key is never stored and is regenerated for each session, the risk of credential compromise is significantly reduced. Furthermore, the use of blockchain technology provides an immutable, auditable record of each transaction, enhancing trust for both buyers and sellers.

For third-party sellers on the on-line retailer store's marketplace, the biometric blockchain card can also be used to securely authenticate seller accounts, authorize high-value transactions, or manage access to sensitive business tools. By requiring biometric authentication for critical actions—such as changing payout information, listing high-value inventory, or accessing sales analytics—the system mitigates the risk of account takeover and fraud. Sellers benefit from streamlined, secure workflows that do not require memorization or management of complex passwords.

Additionally, the integration of this technology supports compliance with evolving data privacy and security regulations. Since neither static private keys nor raw biometric data are stored on the card or transmitted to the retailer's servers, the system aligns with privacy-by-design principles and reduces the risk of data breaches. Customers and sellers alike gain confidence that their identities and transactions are protected by state-of-the-art cryptographic and biometric safeguards, while the on-line retailer store benefits from reduced fraud, improved regulatory compliance, and enhanced customer trust.

This use case demonstrates the versatility and value of the biometric blockchain card system in large-scale, data-driven e-commerce environments. By providing secure, user-centric authentication and transaction verification, the technology addresses critical challenges in online retail and sets a new standard for privacy and security in digital commerce.

The embodiments of the biometric blockchain card may be equipped equipped with multiple embedded communication interfaces, including near field communication (NFC), Bluetooth Low Energy (BLE), and contact-based pads. These interfaces enable the card to interact wirelessly with host devices such as smartphones, tablets, or dedicated readers. This wireless connectivity forms the technical foundation for OTA provisioning, as it allows the card to receive updates, configuration changes, and security patches remotely, without requiring physical access or manual intervention. For example, a smartphone app acting as a gateway can securely transmit firmware updates, new cryptographic algorithms, or revised biometric templates to the card over NFC or BLE. The presence of these interfaces ensures that OTA provisioning is not only feasible but can be implemented securely and efficiently, leveraging existing device infrastructure.

OTA provisioning significantly enhances device security by enabling rapid deployment of critical security patches and updates in response to emerging threats or vulnerabilities. In the context of biometric blockchain devices, this means that manufacturers and service providers can promptly address software bugs, cryptographic weaknesses, or newly discovered attack vectors, thereby reducing the window of exposure to cyber threats. Additionally, OTA updates can be used to enforce compliance with evolving regulatory standards, such as data protection laws (e.g., GDPR) or industry-specific security requirements. For instance, if new regulations mandate stronger encryption or updated biometric processing protocols, these changes can be pushed to all deployed devices remotely, ensuring ongoing compliance without the need for device recalls or manual servicing. This dynamic update capability supports privacy-by-design principles and helps organizations maintain audit-ready, up-to-date security postures.

The modular design and multi-protocol communication capabilities of the biometric blockchain card are crucial for supporting dynamic configuration through remote updates. A modular architecture allows different components—such as biometric sensors, cryptographic processors, and communication modules—to be independently updated or reconfigured as needed. This flexibility is essential for adapting the device to new use cases, integrating additional security features, or supporting new biometric modalities. Multi-protocol communication (NFC, BLE, contact pads) ensures compatibility with a wide range of host devices and network environments, facilitating seamless OTA provisioning regardless of the user's hardware or location. This adaptability is particularly important in large-scale deployments, where devices may be used in diverse operational contexts and require tailored configurations to meet specific organizational or regulatory needs.

OTA provisioning can be tailored to address the unique requirements of various sectors. For example, OTA updates can be used to modify access protocols, update employee credentials, or change authentication software in response to organizational restructuring, role changes, or evolving security policies. For example, if an employee's access level changes, the card can receive new permissions remotely, ensuring that only authorized personnel can enter restricted areas. In another example related to the financial sector, OTA provisioning enables the deployment of new encryption standards, support for emerging digital currencies, or updates to transaction authentication protocols. This ensures that biometric blockchain cards remain compatible with the latest financial technologies and regulatory requirements, while also allowing for the rapid mitigation of security vulnerabilities. In a further example, OTA updates can facilitate real-time synchronization of medical records linked to biometric IDs, ensuring that users have access to the most current health data. Updates can also address changes in healthcare regulations, privacy requirements, or interoperability standards, supporting secure data sharing across different providers and jurisdictions. Also, in electoral contexts, OTA provisioning allows for timely updates to voter registration protocols, biometric verification algorithms, and security features in response to new election laws or emerging threats. This ensures the integrity and security of the voting process, while enabling rapid adaptation to changing legal or technological landscapes.

The integration of OTA provisioning into biometric blockchain devices, as supported by their embedded communication interfaces and modular design, represents a transformative advancement. It enables secure, efficient, and dynamic management of device functionality, security, and compliance across a wide range of applications. By facilitating remote updates and configuration, OTA provisioning ensures that biometric blockchain cards remain resilient, adaptable, and aligned with the highest standards of security and user trust.

Although the subject matter has been described in terms of exemplary embodiments, it is not limited thereto. Rather, the appended claims should be construed broadly, to include other variants and embodiments, which may be made by those skilled in the art.

What is claimed is:

1. A biometric blockchain system for secure communication, comprising:
a biometric sensor powered by induced voltages captured from an electromagnetic field and configured to capture biometric data;
a memory configured to store encrypted templates generated by processing the biometric data;
a processor configured to extract features from the biometric data, transform the extracted features through hashing with a salt to generate a cryptographic private key, authenticate to a private blockchain ledger using the cryptographic private key; and
a communication interface configured to transmit a join request for validation by a consensus mechanism to register a user and to generate session keys for encrypted communications, the encrypted communications recorded as hashes on the private blockchain ledger to verify trust among network participants.

2. The biometric blockchain system of claim 1, wherein the biometric sensor comprises a capacitive fingerprint reader configured to detect ridge and valley patterns through capacitance changes.

3. The biometric blockchain system of claim 1, wherein the biometric sensor comprises a miniature complementary metal-oxide-semiconductor camera with infrared capabilities configured for facial recognition.

4. The biometric blockchain system of claim 1, wherein transforming the extracted features through hashing comprises using secure hash algorithm 256 combined with a salt.

5. The biometric blockchain system of claim 1, applying error correction including using fuzzy extractors based on Reed-Solomon codes to correct errors within a Hamming distance tolerance.

6. The biometric blockchain system of claim 1, wherein the cryptographic private key comprises an elliptic curve cryptography private key based on the secp256k1 curve.

7. The biometric blockchain system of claim 1, wherein the private blockchain ledger is configured as a permissioned network based on Hyperledger Fabric with proof-of-authority consensus.

8. The biometric blockchain system of claim 1, wherein the consensus mechanism comprises practical Byzantine fault tolerance with 3f+1 nodes to validate the join request.

9. The biometric blockchain system of claim 1, wherein the induced voltages are captured via an antenna structure comprising inductive coils tuned to 13.56 MHz radio frequency signals.

10. The biometric blockchain system of claim 1, wherein the biometric sensor is configured to support liveness detection through pulse oximetry diodes measuring blood flow via light absorption at multiple wavelengths.

11. The biometric blockchain system of claim 1, wherein the processor is further configured to perform match-on-card processing by comparing generated templates against stored encrypted templates using Euclidean distance metrics.

12. The biometric blockchain system of claim 1, wherein the communication interface further comprises near field communication via an integrated antenna tuned to 13.56 MHz for ISO/IEC 14443 compliance.

13. The biometric blockchain system of claim 1, wherein the communication interface further comprises bluetooth low energy operating at 2.4 GHz with support for bluetooth low energy 5.0 protocols.

14. The biometric blockchain system of claim 1, wherein communication interface operates on a smartphone configured as a gateway to interface with the private blockchain ledger for peer-to-peer synchronization.

15. The biometric blockchain system of claim 1, wherein generating session keys comprises deriving symmetric keys from blockchain-authenticated sessions using Diffie-Hellman bound to the cryptographic private key.

16. The biometric blockchain system of claim 1, wherein the encrypted communications are logged as hashes including transaction metadata comprising timestamps for auditability.

17. The biometric blockchain system of claim 1, wherein the private blockchain ledger uses zero-knowledge proofs to prove identity without revealing templates during authentication.

18. A biometric blockchain device for secure communication, comprising:
a biometric sensor powered by induced voltages captured from an electromagnetic field and configured to capture biometric data;
a memory configured to store encrypted templates generated by processing the biometric data;
a processor configured to extract features from the biometric data, transform the extracted features through hashing with a salt, apply error correction to the transformed features to generate a cryptographic private key, and authenticate to a private blockchain ledger using the cryptographic private key; and
a communication interface configured to transmit a join request for validation by a consensus mechanism to register a user, and to generate session keys for encrypted communications, the encrypted communications recorded as hashes on the private blockchain ledger to verify trust among network participants.

19. A method for secure communication using a biometric blockchain system, comprising:
capturing biometric data with a biometric sensor powered by a power source;
processing the biometric data to generate encrypted templates stored in a memory;
extracting features from the biometric data;
transforming the extracted features through hashing with a salt;
applying error correction to the transformed features to generate a cryptographic private key;
authenticating to a private blockchain ledger using the cryptographic private key;
transmitting a join request via a communication interface, the join request validated by a consensus mechanism to register a user; and
generating session keys for encrypted communications, the encrypted communications recorded as hashes on the private blockchain ledger to verify trust among network participants.

20. A method for secure messaging using a biometric blockchain card, comprising:
capturing biometric samples with a biometric sensor embedded in a layered core of the biometric blockchain card powered by a power source;
pre-processing the biometric samples to create encrypted templates stored in memory;
extracting features from the biometric samples;
transforming the features via hashing with a salt;
correcting the transformed features using error correction to yield a cryptographic private key;
authenticating to a private ledger using the cryptographic private key;
broadcasting a join request via a communication interface embedded in the layered core for validation by consensus to add a user; and
deriving session keys for encrypted messages logged as hashes on-chain for trust verification among group members.
